(19) United States
(12) Patent Application Publication
(10) Pub. No.: US 2004/0004640 A1
(43) Pub. Date: Jan. 8, 2004

(54) Data processing terminal and method and program for causing the same to transfer to a desired tag

(75) Inventor: Yasuhiro Iida, Tokyo (JP)

Correspondence Address: McGinn & Gibb, PLLC, Suite 200, 8321 Old Courthouse Road, Vienna, VA, 22182-3817, US

(73) Assignee: NEC Corporation, Tokyo (JP)

(21) Appl. No.: 10/610,874

(22) Filed: Jul. 2, 2003

(30) Foreign Application Priority Data
Mar. 7, 2002 (JP) 194046/2002

(51) Int. Cl. G09G 5/00

(52) U.S. Cl. 345/810

(57) ABSTRACT

A data processing terminal of the present invention is configured to perform transfer to a position where, among data provided by a data provider, a tag representative of control information buried in the data exists. The terminal includes a data acquirer for acquiring the data from the data provider via a communication network, a tag analyzer for analyzing tags included in the data acquired by the data acquirer, a display device for displaying the data on the basis of the result of analysis output from the tag analyzer, and a tag searcher for searching the data for a desired tag input from the outside. The display device displays part of the data corresponding to the tag searched for by the tag searcher.

### BACKGROUND OF THE INVENTION

1. Field of the Invention

The present invention relates to a data processing terminal and a method and a program for causing the same to transfer to a desired tag and more particularly to a method of searching for and displaying part of a home page including a desired tag.

2. Description of the Background Art

It is a common practice with a Web terminal or similar data processing terminal to use HTML (Hyper Text Markup Language) browser software for watching a homepage. The HTML browser software will be simply referred to as an HTML browser hereinafter. Also, other browser software will be simply referred to as a browser. Assume that the operator of the data processing terminal desires to make inquiries about a homepage, which the operator is watching with the HTML browser. Then, the operator usually searches for a portion where the mail address attribute, e.g., MailTo of an anchor tag or, in the case of an HTML browser capable of recognizing a telephone number, PhoneNo or similar telephone number attribute is indicated.

Because the HTML browser lacks means for directly searching for the tag or the attributed mentioned above, the operator is required to confirm a content designated by an anchor tag while scrolling the homepage with eye. It is to be noted that a tag refers to control information buried in a homepage. The operator is required to perform the above operation even when watching an XML (extensible Markup Language) file.

Thus, it is extremely difficult for the operator of the conventional data processing terminal to search a homepage for a desired tag or a desired attribute. For example, a browser installed in a mobile personal telephone or a PDA (Personal Digital Assistant) cannot display the entire source file at a time because of the limited area of a display screen available therewith, making it extremely difficult for the operator to grasp an attribute from the entire source file.

Technologies relating to the present invention are also disclosed in, e.g., Japanese Patent Laid-Open Publication Nos. 10-293767, 11-306205, 2000-181840 and 2002-16849 and WO 98/12871.

### SUMMARY OF THE INVENTION

It is an object of the present invention to provide a data processing terminal capable of directly searching a home page for a desired tag or a desired attribute and easily transferring to the position of the desired tag or that of the desired attribute, and a method and a program for causing the same to transfer to the above position.

A data processing terminal of the present invention is configured to perform transfer to a position where, among data provided by a data provider, a tag representative of control information buried in the data exists. The terminal includes a data acquirer for acquiring the data from the data provider via a communication network, a tag analyzer for analyzing tags included in the data acquired by the data acquirer, a display device for displaying the data on the basis of the result of analysis output from the tag analyzer, and a tag searcher for searching the data for a desired tag input from the outside. The display device displays part of the data corresponding to the tag searched for by the tag searcher.

A method and a program for causing the above data processing terminal to transfer to the position of a desired tag are also disclosed.

### BRIEF DESCRIPTION OF THE DRAWINGS

The above and other objects, features and advantages of the present invention will become more apparent from the following detailed description taken with the accompanying drawings in which:

FIG. 1 is a schematic block diagram showing a data processing terminal embodying the present invention;

FIG. 2 is a flowchart demonstrating a specific procedure to be executed by a tag analyzer included in the illustrative embodiment;

FIG. 3 is a schematic block diagram showing an alternative embodiment of the present invention implemented as a Web terminal;

FIG. 4 is a flowchart showing a specific operation of an HTML tag analyzer included in the embodiment of FIG. 3;

FIG. 5 shows specific transition of a picture effected by an HTML browser included in the embodiment of FIG. 3;

FIG. 6 is a flowchart showing a specific operation of the HTML tag analyzer representative of another alternative embodiment of the present invention;

FIG. 7 shows specific transition of a picture effected by the HTML browser included in the embodiment of FIG. 6;

FIG. 8 shows specific transition of a picture effected by the HTML browser representative of still another alternative embodiment of the present invention; and

FIG. 9 is a flowchart demonstrating a specific procedure to be executed by the tag analyzer representative of a further embodiment of the present invention.

### DESCRIPTION OF THE PREFERRED EMBODIMENTS

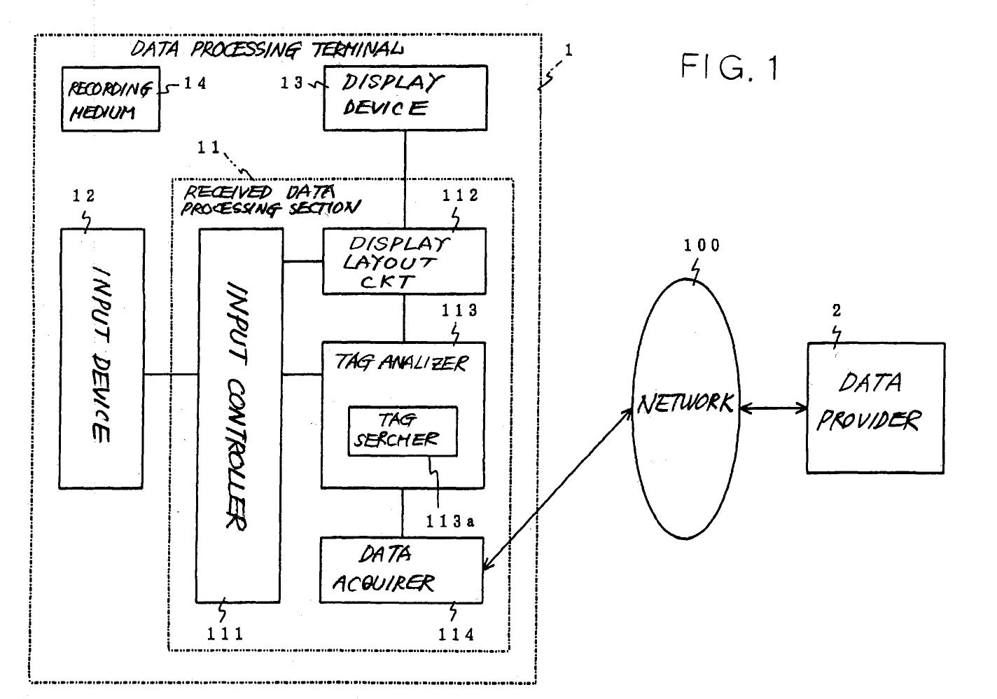

Referring to FIG. 1 of the drawings, a data processing terminal embodying the present invention is shown and generally designated by the reference numeral 1. As shown, the data processing terminal 1 is generally made up of a received data processing section 11, an input device 12, a display device 13 and a recording medium 14 and connected to a data provider 2 via a communication network 100.

The communication network 100 may be any one of Internet, intranet and other communicating means. Also, the data provider 2 may be any one of data providing means of the kind providing a file that can be designated by a tag in the event of, e.g., display, e.g., an XML server, an HTML server, an XHTML (extensible Hyper Text Markup Language) server or a data base. A tag refers to control data buried in a file to be provided, as stated earlier.

The received data processing section 11 includes an input controller 111, a display layout circuit 112, a tag analyzer 113 including a tag searcher 113a, and a data acquirer 114. The received data processing section 11, which may be constituted by software, is implemented by a computer, not shown, capable of executing a program stored in the recording medium 14. The input controller 111 controls the input device 12.

The received data processing section 11 transfers information on the data provider 2 input via the input device 12 to the data acquirer 114 and then acquires data from the data acquirer 2 via the communication network 100. When the received data processing section 11 receives data from the data provider 2, the tag analyzer 113 analyzes tags included in the received data. Subsequently, display data generated by the display layout circuit 112 are displayed on the display device 13.

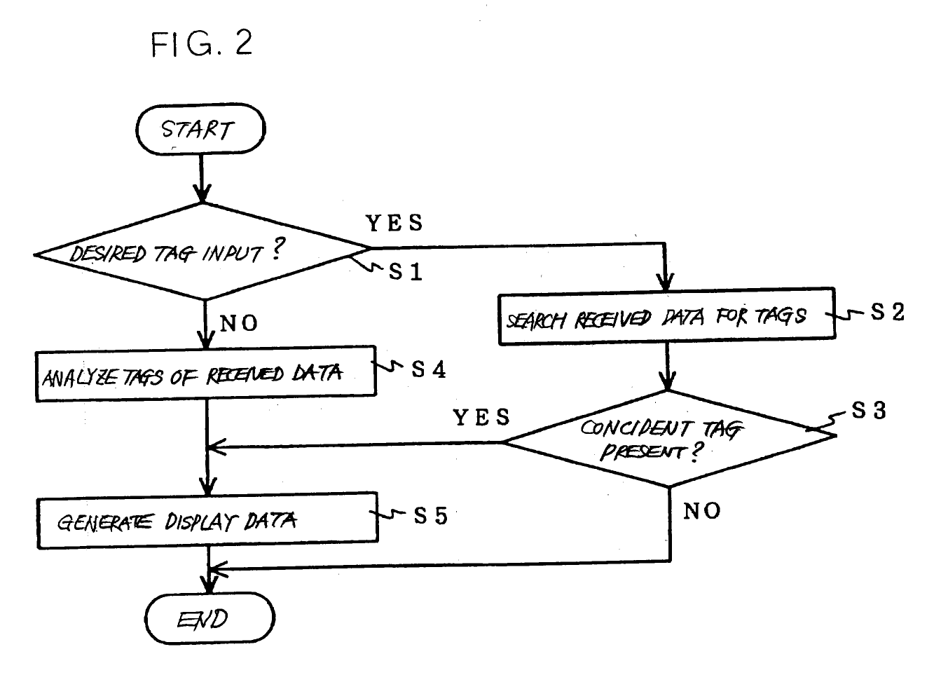

FIG. 2 demonstrates a specific procedure to be executed by the tag analyzer 113. The operation of the illustrative embodiment will be described with reference to FIGS. 1 and 2. First, transfer to the position of a desired tag or that of a desired attribute and included in the display data appearing on the display device 13 will be described. It is to be noted that the procedure shown in FIG. 2 is included in the program of the recording medium 14 to be executed by the computer. The following description will concentrate on transfer to part of the display data where PhoneNo is described by way of example. PhoneNo is one of telephone number tag attributes customary with browser software (simply browser hereinafter) that can recognize telephone numbers.

Before the procedure of FIG. 2, the operator of the data processing terminal 1, watching the display data on the display device 13, inputs a character train indicative of a desired tag or a desired attribute on the input device 12, which is controlled by the input controller 111. The operator then presses a processing start key, not shown, located at an adequate position. In response, the tag searcher 113a included in the tag analyzer 113 determines whether or not a tag character train to be searched for is designated (step S1, FIG. 2). If the answer of the step S1 is positive (YES), then the tag searcher 113a searches the received data for the tag character train. (step S2).

Subsequently, the tag analyzer 113 determines, based on the result of the step S2, whether or not the designated tag character train is present in the display data being watched (step S3). If the answer of the step S3 is YES, then the tag analyzer 113 generates display data representative of a portion including the desired tag (step S5) and delivers the display data thus generated to the display layout circuit 112. The display layout circuit 112 lays out the display data and causes the display device 13 to display the resulting display data.

On the other hand, if the answer of the step S1 is negative (NO), then the tag analyzer 113 determines that received data are to be displayed for the first time or redisplayed. In this case, the tag analyzer 113 analyzes tags included in the received data as usual (step S4) and then generates display data corresponding to the received data (step S5).

As stated above, the illustrative embodiment realizes easy transfer to the position of a desired tag included in display data, which correspond to received data. This makes it unnecessary for the operator to scroll display data while watching the display data and confirm a content designated by an anchor tag with eye, thereby noticeably simplifying transfer to a desired tag position.

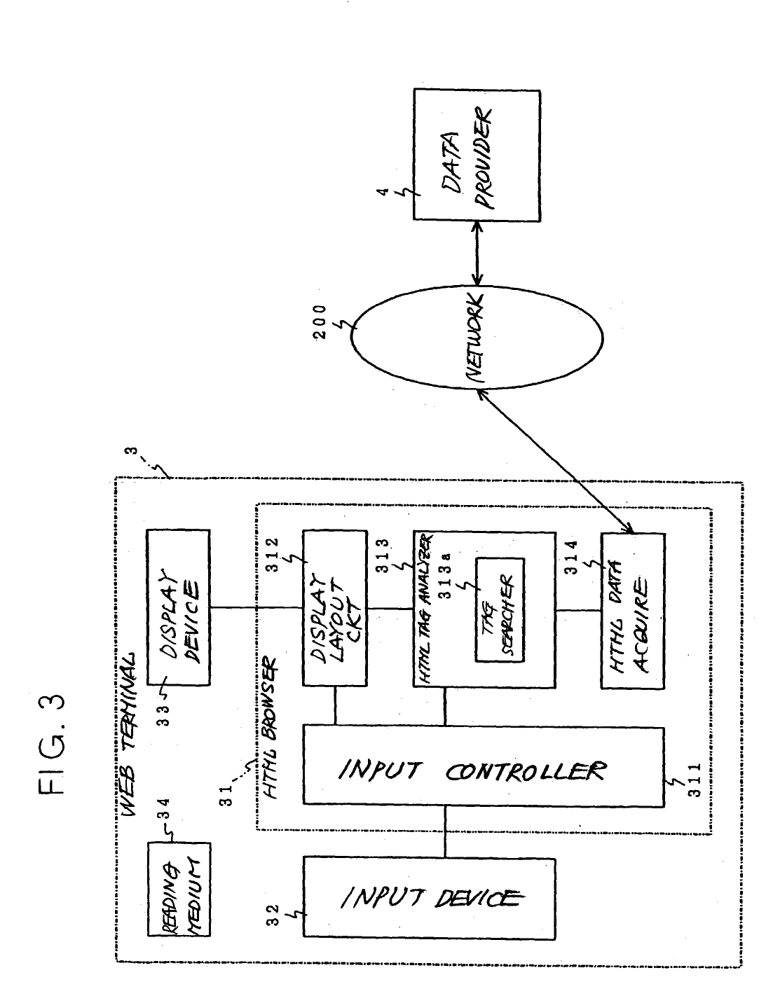

Reference will be made to FIG. 3 for describing an alternative embodiment of the present invention and implemented as a Web terminal. As shown, the Web terminal, generally 3, includes an HTML browser 31, an input device 32, a display device 33 and a recording medium 34 and connected to an HTML server 4 via Internet 200.

The HTML browser 31 includes an input controller 311, an HTML data acquirer 314, an HTML tag analyzer 313 including a tag searcher 313a, and a display layout circuit 312. Generally, the HTML browser 31 is constituted by software and implemented by a computer, not shown, which is associated with the Web terminal 3 and executes a program stored in the recording medium 34. The input controller 311 controls the input device 32.

The HTML browser 31 transfers a URL (Uniform Resource Locator) input via the input device 32 to the HTML data acquirer 314 and then acquires HTML data from the HTML server 4 via Internet 200. Subsequently, in the HTML browser 31, the HTML tag analyzer 313 analyzes tags included in the HTML data. Thereafter, homepage display data arranged by the display layout circuit 312 are displayed on the display device 33.

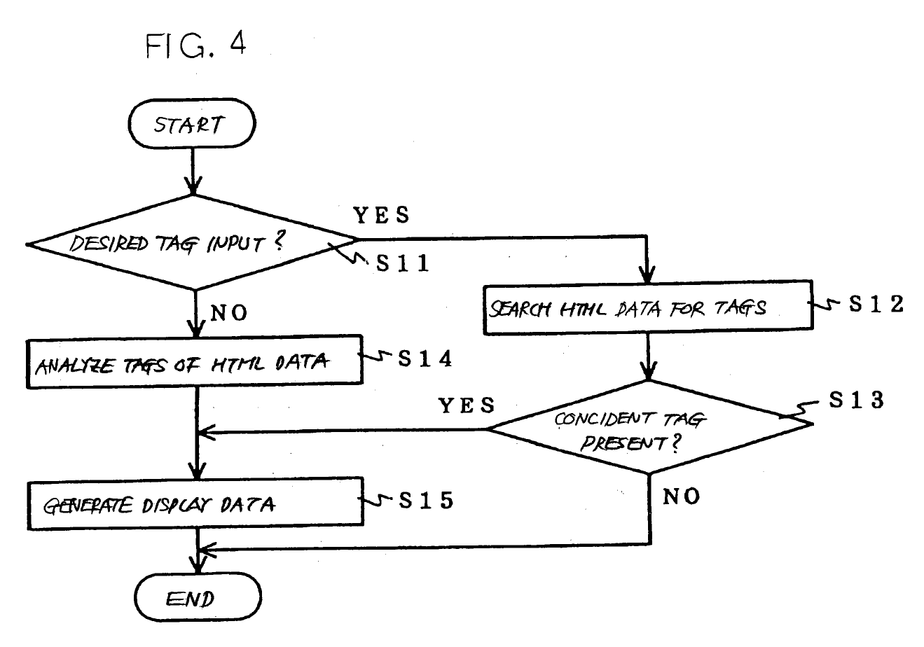

FIG. 4 demonstrates a specific procedure to be executed by the HTML tag analyzer 313 while FIG. 4 shows specific transition of a picture effected by the HTML browser 31. The operation of the Web terminal 3 will be described with reference to FIGS. 3 through 5. It is to be noted that the procedure shown in FIG. 4 is included in the program of the recording medium 34 to be executed by the computer.

Transfer to the position of a desired tag or that of a desired attribute included in a homepage being watched will be described hereinafter. Again, the following description will concentrate on transfer to part of the homepage where. PhoneNo is described by way of example.

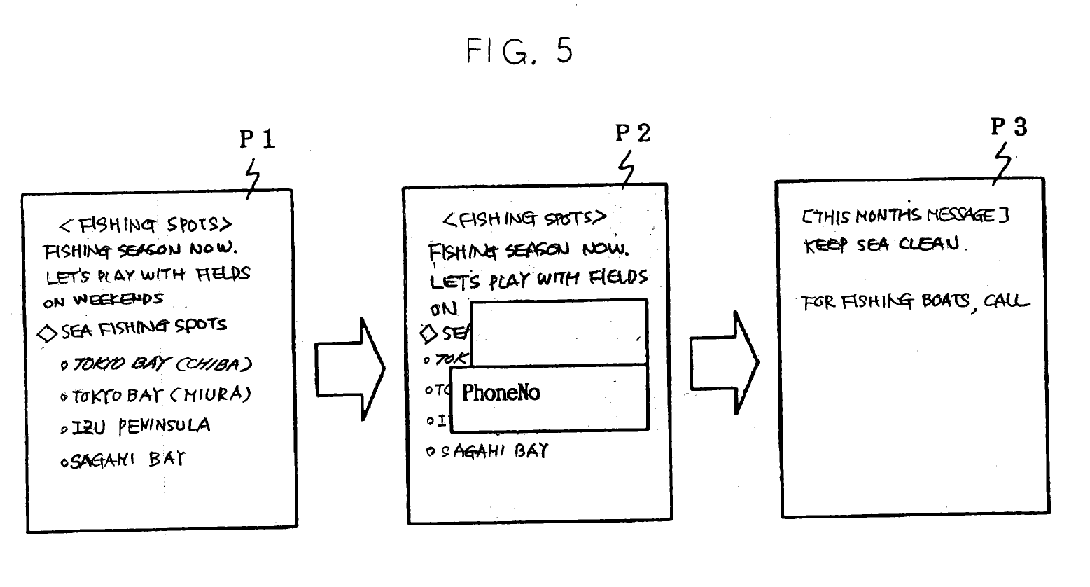

First, the operator of the Web terminal 3, watching a homepage (picture P1, FIG. 5), inputs a character train (PhoneNo) indicative of a desired tag or a desired attribute, which is indicated in italic in the picture P1 for distinction. A picture P2 in FIG. 5 shows the resulting condition of the homepage. The operator then presses a processing start key, not shown, located at an adequate position. In response, the HTML tag analyzer 313 causes its tag searcher 313a to determine whether or not a tag character train to be searched for is present (step S1, FIG. 4). If the answer of the step S11 is YES, then the tag searcher 313a searches the HTML data for the tag character train (PhoneNo) (step S12).

The tag analyzer 313 determines, based on the result of search performed by the tag searcher 313a, whether or not the tag character train is present (step S13). If the answer of the step S13 is YES, meaning that the designated tag character train (PhoneNo) is present on the homepage, then the HTML tag analyzer 313 generates display data corresponding to a portion including the designated tag (step S15).

The homepage display data thus generated are laid out by the display layout circuit 312 and then displayed on the display device 33 (pictureP3, FIG. 5). As a result, in the illustrative embodiment, the picture P3, describing <A HREF=“PhoneNo:0312345678”>call</A>on the homepage, appears on the display device 33; “call” to which transfer is made is indicated in italics.

On the other hand, if the answer of the step S11 is NO, then the tag analyzer 313 determines that received data are to be displayed for the first time or redisplayed. In this case, the tag analyzer 313 analyzes tags included in the received HTML data as usual (step S14) and then generates homepage display data (step S15).

It should be noted that the telephone number attribute PhoneNo shown and described is merely a specific tag attribute to be searched for and may be replaced with any other character train representative of, e.g., a mail address attribute MilTo. In such a case, too, transfer to the position of the desired tag will be effected if the tag is present on a homepage.

With the configuration described above, the illustrative embodiment achieves the same advantage as the previous embodiment.

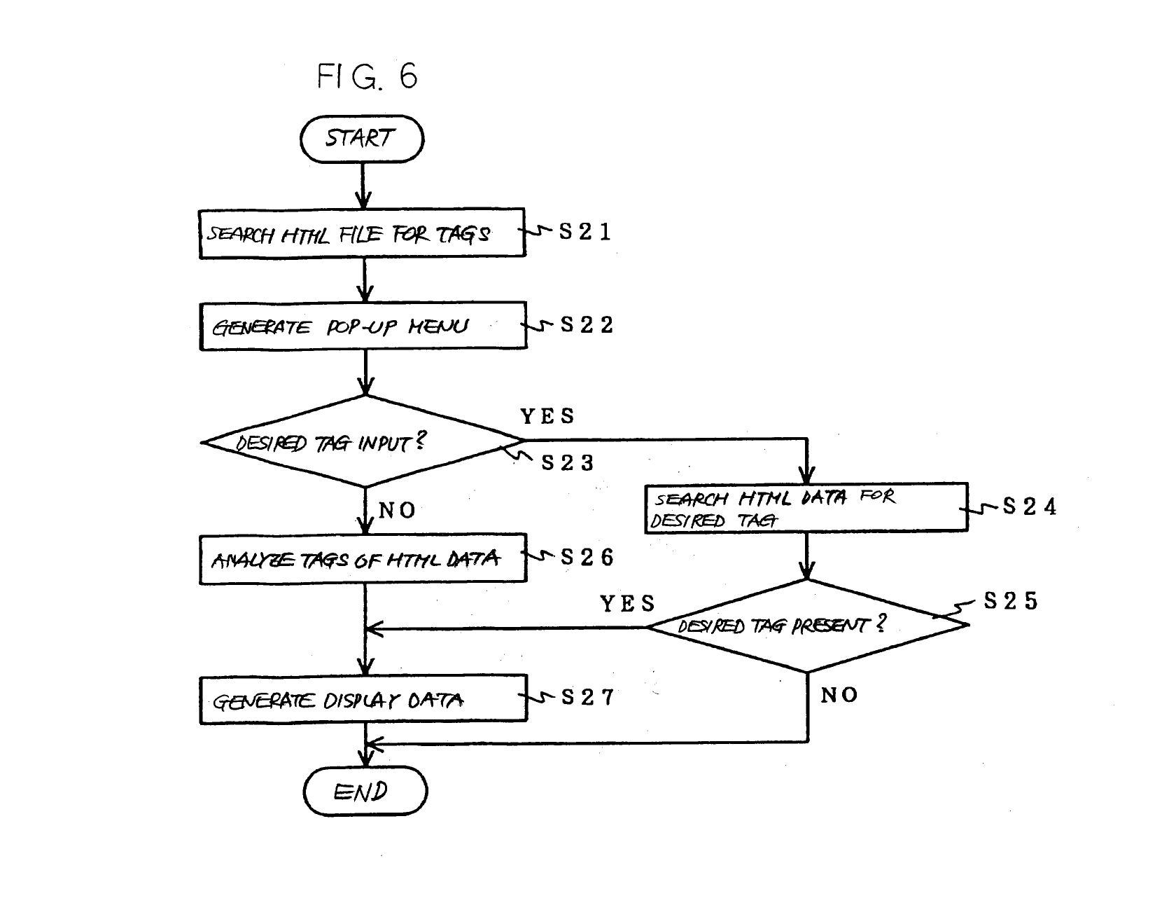

FIG. 6 shows a specific operation of the HTML tag analyzer representative of another alternative embodiment of the present invention and also practicable with the Web terminal 3 shown in FIG. 3. The operation of the illustrative embodiment will be described with reference to FIGS. 3, 6 and 7. It is to be noted that the procedure shown in FIG. 6 is included in the program of the recording medium 34 to be executed by the computer.

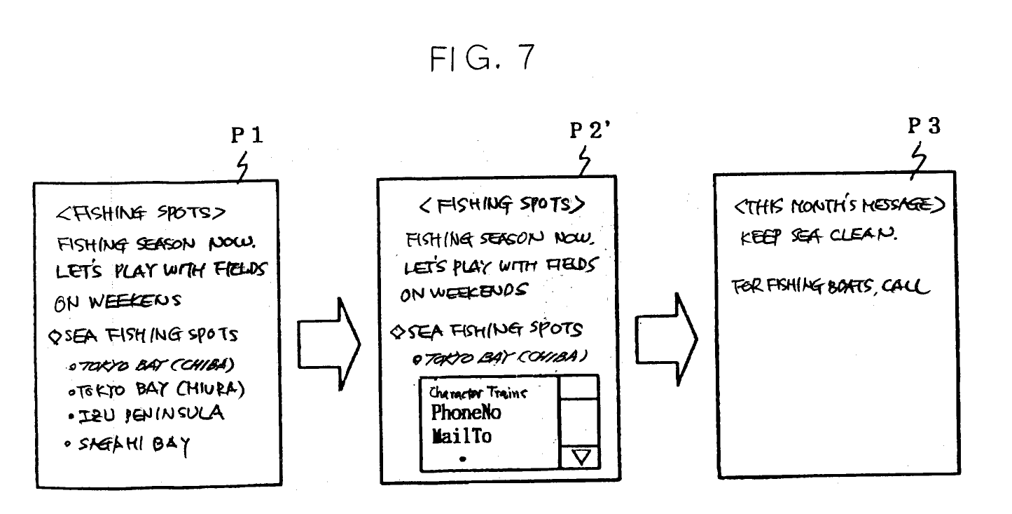

In the illustrative embodiment, because the number of tags available with a homepage is limited, the HTML tag analyzer searches for all tags present on an HTML file (step S21, FIG. 6). The tags thus searched for are displayed in the form of a pop-up menu (step S22) (see a picture P2′, FIG. 7). When the operator selects desired one of the tags included in the pop-up menu, steps S23 through S27 are sequentially executed in the same manner as the steps S11 through S15 of FIG. 4. As a result, homepage display data are generated, laid out by the display layout circuit 312, and then displayed on the display device 33 (see a picture P3, FIG. 7).

In the picture P2′ of FIG. 7, a telephone number attribute PhoneNo and a mail address attribute MailTo searched for in the step S21 are shown as appearing in the form of a pop-up menu by way of example.

With the configuration described above, the illustrative embodiment achieves the same advantage as the previous embodiments.

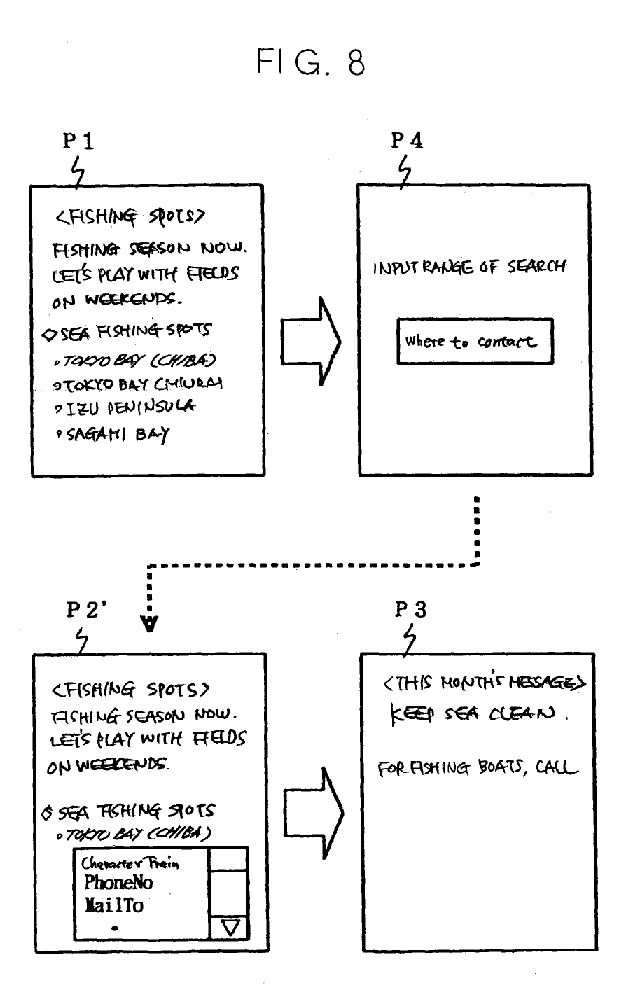

FIG. 8 shows specific transition of a picture effected by an HTML browser representative of still another alternative embodiment of the present invention. As shown, the transition differs from the transition of FIG. 7 in that a picture P4, which allows the operator to select the range of tags to be listed in the pop-up menu P2′ beforehand, appears before the pop-up menu P2′. More specifically, when the operator inputs the range of search (“where to contact” in FIG. 8) beforehand, the illustrative embodiment searches for, e.g., PhoneNo and MailTo without searching every tag of the HTML file and displays them in the pop-up menu P2′.

With the configuration described above, the illustrative embodiment achieves the same advantage as the previous embodiments.

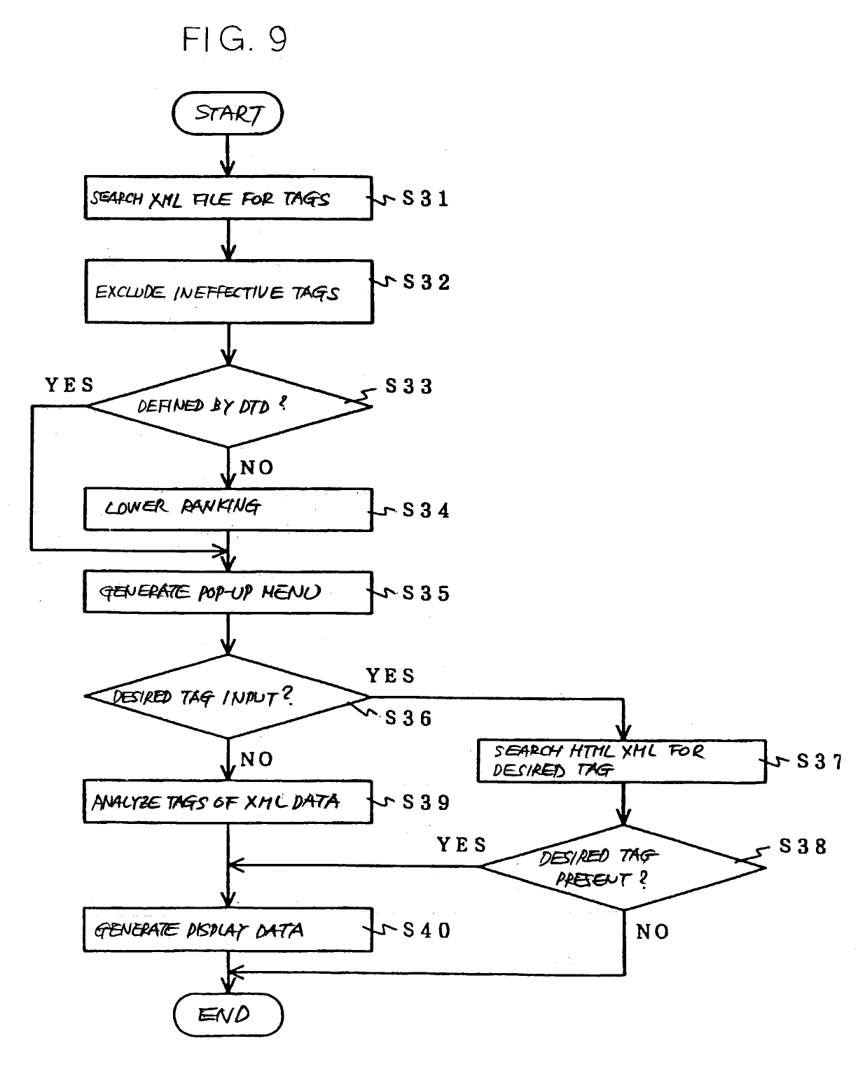

FIG. 9 shows another specific operation of the tag analyzer representative of a further alternative embodiment of the present invention. This embodiment is also practicable with the data processing terminal shown in FIG. 1 and will therefore be described with reference to FIGS. 1 and 9. It is to be noted that the procedure shown in FIG. 9 is included in the program of the recording medium 14 to be executed by the computer. The illustrative embodiment is applied to transfer to a tag position included in an XML file.

As shown in FIG. 9, the tag analyzer 113 searches the XML file for all tags present therein (step S31) and then excludes “TITLE” and other reserved words of general use, which are not effective for information search, from the range of search (step S32). Further, the tag analyzer 113 lowers the ranking of tags not defined by DTD (Document Type Definition), i.e., searches for tags defined by DTD prior to the others (steps S33 and S34). One or both of the steps S32 and S33 may be executed, as the case may be.

The tags of the XML file thus searched for are displayed in order of ranking in the form of a pop-up menu (step S35). When the operator selects a desired tag in the pop-up menu, i.e., when a tag character train to be searched for is input (YES, step S36), the tag searcher 113a searches the XML data for the designated tag character train (step S37).

The tag analyzer 113 determines, based on the result of search performed by the tag searcher 113a, whether or not the desired tag character train is present in the display data (step S38). If the answer of the step S38 is YES, then display data corresponding to the desired tag are generated (step S40), laid out by the display layout circuit 112, and then displayed on the display device 13.

If the answer of the step S38 is NO, meaning that the operator has not selected any tag listed in the pop-up menu, then the tag analyzer 113 determines that received data are to be displayed for the first time or redisplayed. In this case, the tag analyzer 113 analyzes tags included in the received data as usual (step S39) and then generates display data corresponding to the received data (step S40).

With the configuration described above, the illustrative embodiment also achieves the same advantage as the previous embodiments.

In summary, in accordance with the present invention, it is possible to directly search for a desired tag or a desired attribute on a homepage and easily, immediately transfer to a position where the attribute exists. This makes it unnecessary for the operator to confirm a content designated by an anchor tag with eye while scrolling a homepage, thereby noticeably simplifying transfer to a desired tag position. This is also true with a mobile personal telephone, PDA (Personal Data Assistant) or similar personal apparatus whose display screen is small.

Various modifications will become possible for those skilled in the art after receiving the teachings of the present disclosure without departing from the scope thereof.

What is claimed is:

1. A data processing terminal capable of performing transfer to a position where, among data provided by a data provider, a tag representative of control information buried in said data exists, said data processing terminal comprising:
acquiring means for acquiring the data from the data provider via a communication network;
analyzing means for analyzing tags included in the data acquired by said acquiring means;
displaying means for displaying the data on the basis of a result of analysis output from said analyzing means; and
searching means for searching the data for a desired tag input from an outside;
wherein said displaying means displays part of the data corresponding to the tag searched for by said searching means.

2. The terminal as claimed in claim 1, wherein the tags searched for are displayed in a pop-up menu, and said searching means searches said pop-up menu for the desired tag.

3. The terminal as claimed in claim 2, wherein the tags are displayed in the pop-up menu in order of priority.

4. The terminal as claimed in claim 1, wherein the data acquired from the data provider are at least one of XML (extensible Markup Language) data, HTML (Hyper Text Markup Language) data and XHTML (extensible Hyper Test Markup Language) data.

5. The terminal as claimed in claim 4, wherein the tags searched for are displayed in a pop-up menu, and said searching means searches said pop-up menu for the desired tag.

6. The terminal as claimed in claim 5, wherein the tags are displayed in the pop-up menu in order of priority.

7. A method of causing a data processing terminal to transfer to a position where, among data provided by a data provider, a tag representative of control information buried in said data exists, said method comprising the steps of:
acquiring the data from the data provider via a communication network;
analyzing tags included in the data acquired;
displaying the data on the basis of a result of analysis; and
searching the data for a desired tag input from an outside;
wherein part of the data corresponding to the tag searched for is displayed.

8. The method as claimed in claim 7, further comprising displaying the tags searched for in a pop-up menu, and searching said pop-up menu for the desired tag.

9. The method as claimed in claim 8, further comprising displaying the tags in the pop-up menu in order of priority.

10. The method as claimed in claim 7, wherein the data acquired from the data provider are at least one of XML (extensible Markup Language) data, HTML (Hyper Text Markup Language) data and XHTML (extensible Hyper Test Markup Language) data.

11. The method as claimed in claim 10, further comprising displaying the tags searched for in a pop-up menu, and searching said pop-up menu for the desired tag.

12. The method as claimed in claim 11, further comprising displaying the tags in the pop-up menu in order of priority.

13. A program for practicing a method of causing a data processing terminal to transfer to a position where, among data provided by a data provider, a tag representative of control information buried in said data exists, said program causing a computer to execute:
processing for acquiring the data from the data provider via a communication network;
processing for analyzing tags included in the data acquired;
processing for displaying the data on the basis of a result of analysis; and
processing for searching the data for a desired tag input from an outside and displaying part of the data corresponding to the tag searched for.
